(19) United States
(12) Patent Application Publication
(10) Pub. No.: US 2007/0060145 A1
(43) Pub. Date: Mar. 15, 2007

(54) Method for allocating downlink resources in a communication system

(75) Inventors: Yoo-Seung Song, Yongin-si (KR); Jung-Won Kim, Seoul (KR); Hee-Kwang Lee, Suwon-si (KR); Jeong-Ho Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/489,016

(22) Filed: Jul. 19, 2006

(30) Foreign Application Priority Data
Jul. 19, 2005 (KR) 65325/2005

(51) Int. Cl. H04Q 7/20

(52) U.S. Cl. 455/445

(57) ABSTRACT

Disclosed is a method for resource allocation for a data burst in a communication system having a frame which is divided according time and frequency and includes a data burst allocation region. The method includes constructing the frame to have a structure in which the data burst allocation region is divided into at least one sub-data burst region for power amplification at a preset power level; and allocating the data burst to the sub-data burst region according to a standard.

### PRIORITY

This application claims the benefit under 35 U.S.C. § 119(a) of an application filed in the Korean Industrial Property Office on Jul. 19, 2005 and assigned Serial No. 2005-65325, the contents of which are incorporated herein by reference.

### BACKGROUND OF THE INVENTION

1. Field of the Invention

The present invention relates to a communication system, and more particularly to a method for allocating downlink resources in a communication system.

2. Description of the Related Art

In a 4^{th} generation (4G) communication system, which is the next generation communication system, research has been actively conducted to provide users with services having various qualities of service (QoS) and supporting a high transmission speed of about 100 Mbps. Currently, in the 4G communication system, research has been actively conducted to support high speed services while ensuring the mobility and QoS in a wireless Local Area Network (LAN) and a wireless Metropolitan Area Network (MAN) system. One such communication systems is the Institute of Electrical and Electronics Engineers (IEEE) 802.16 standard based communication system.

The IEEE 802.16 communication system is a communication system which employs an Orthogonal Frequency Division Multiplexing (OFDM)/Orthogonal Frequency Division Multiple Access (OFDMA) scheme in order to support a broadband transmission network for the wireless MAN system. According to the OFDM or OFDMA scheme, orthogonality is maintained between a plurality of sub-carriers when the sub-carriers are transmitted, so that it is possible to obtain an optimum transmission efficiency. Further, the OFDM or OFDMA scheme has a good frequency use and is robust against multi-path fading, so that the system can achieve an optimum transmission efficiency for high speed data transmission.

In a communication system using the OFDMA scheme, it is necessary to properly distribute and use resources in order to enhance the use of channels between a base station and a plurality of mobile stations located in one cell. In a communication system using the OFDMA scheme, a sub-carrier is one shared resource, and the guarantee of an optimum channel use depends on the way in which the sub-carriers are allocated to mobile stations within a cell. A set including at least one sub-carrier constitutes a sub-channel.

In the broadband wireless access communication system, data is transmitted on a frame-by-frame basis, and each frame includes an interval for transmission of downlink data and an interval for transmission of uplink data. Each of the uplink data transmission interval and the downlink data transmission interval is divided into elements according to the frequency axis and the time axis. Each of the elements in the two-dimensional arrangement according to the frequency axis and the time axis is referred to as “slot.”

The base station uses a normal MAP, a new normal MAP, or an H-ARQ (Hybrid Automatic Retransmission Request) MAP, in order to allocate downlink data bursts to the mobile stations. The data bursts occupy a plurality of time slots and are allocated to the downlink data interval. A scheme for improving the use of the downlink resources by performing power boosting or power de-boosting for the data bursts allocated for the base station is defined in the communication system standard, for example, the IEEE 802.1 6e standard. The communication system standard defines the power boosting or de-boosting levels as {−12, −9, −6, −3, 0, 3, 6, 9, 12} dB.

However, a specific scheme for allocating the data bursts to data burst regions is not found in the communication standard. The way in which the data bursts are allocated to data burst regions may cause a big difference in use and efficiency of the resources.

### SUMMARY OF THE INVENTION

Accordingly, the present invention has been made to solve at least the above-mentioned problems occurring in the prior art, and an aspect of the present invention is to provide a method for effectively allocating downlink data bursts in order to maximize the use of resources in a communication system.

In order to accomplish this aspect, there is provided a method for resource allocation for a data burst in a communication system having a frame which is divided according time and frequency and includes a data burst allocation region, the method includes constructing the frame to have a structure in which the data burst allocation region is divided into at least one sub-data burst region for power amplification of a preset power level; and allocating the data burst to the sub-data burst region according to a standard.

In accordance with another aspect of the present invention, there is provided a method for resource allocation for a data burst in a communication system having a frame divided according time and frequency and data bursts to be transmitted to a mobile station, the frame including a MAP region and a data burst allocation region, the MAP region carrying broadcast information, the method includes constructing the frame to have a structure in which the data burst allocation region is divided into at least one sub-data burst region for power amplification of a preset power level, the sub-data burst region including at least one group divided according to a sub-channel; allocating the data burst to the sub-data burst region according to a standard; when the sub-data burst region includes enough slots to be occupied by all of the data burst, selecting a group having a lowest number of remaining slots after occupancy of the data burst; and allocating the data burst to the selected group.

In accordance with another aspect of the present invention, there is provided a method for resource allocation for a data burst in a communication system having a frame divided according time and frequency and data bursts to be transmitted to a mobile station, the frame including a MAP region and a data burst allocation region, the MAP region carrying Hybrid-ARQ broadcast information, the method includes constructing the frame to have a structure in which the data burst allocation region is divided into at least one sub-data burst region for power amplification of a preset power level; allocating the data burst to the sub-data burst region according to a standard; and when the sub-data burst region includes enough slots to be occupied by all of the data burst, sequentially allocating the data burst to the slots along a frequency axis.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a structure of a downlink frame of a communication system according to the present invention;

FIG. 2 is a flowchart of a process for resource allocation in a communication system according to the present invention;

FIG. 3 is a view for illustrating allocation of data bursts to a plurality of regions divided from a data burst region in a communication system according to the present invention;

FIG. 4 is a flowchart of a process for data burst allocation in the case of using the normal MAP in a communication system according to the present invention; and

FIG. 5 is a flowchart of a process for data burst allocation in the case of using the new DL MAP or H-ARQ MAP in a communication system according to the present invention.

### DETAILED DESCRIPTION OF THE PREFERRED EMBODIMENT

Hereinafter, preferred embodiments of the present invention will be described with reference to the accompanying drawings. In the following description, a detailed description of known functions and configurations incorporated herein will be omitted when it may make the subject matter of the present invention rather unclear.

The present invention provides a method for effectively allocating downlink data bursts to a predetermined downlink frame in a communication system. The predetermined downlink frame may include a preamble region, a MAP region, and a data burst allocation region. The data burst allocation region may include either a data burst allocation region to which the power boosting or de-boosting is not applied, or at least one sub-data burst region to which the power boosting or de-boosting is applied. Although the data burst allocation region include two or three sub-data burst regions described below, it should be noted that the data burst allocation region of the present invention may include either one sub-data burst region or more than three sub-data burst regions.

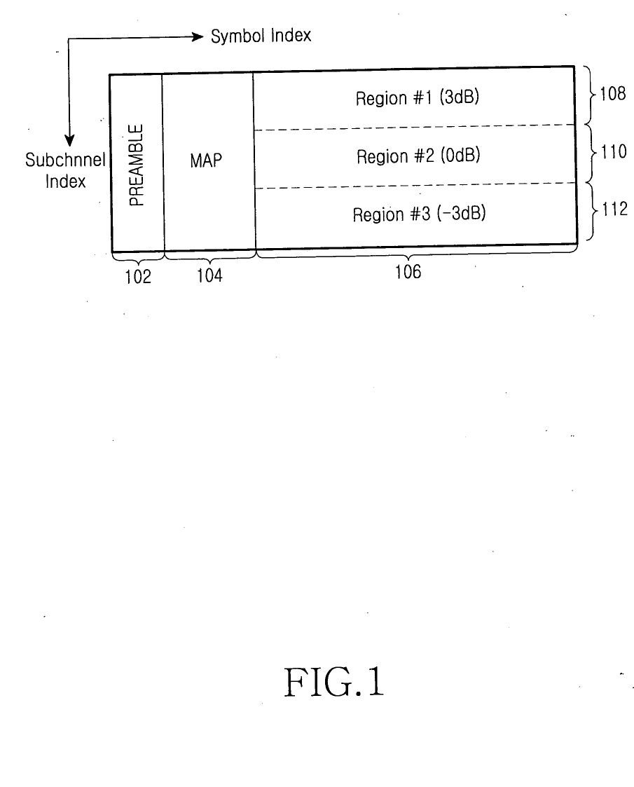

FIG. 1 illustrates a structure of a downlink frame of a communication system according to the present invention.

Referring to FIG. 1, the downlink frame includes a preamble region 102, a MAP region 104, and a data burst allocation region 106. A preamble for acquisition of synchronization is located in the preamble region 102, and the MAP region 104 includes DL-MAP (downlink MAP) and UL-MAP (uplink MAP) including broadcast data information commonly received by mobile stations. The data burst allocation region 106 is allocated downlink data bursts transmitted to the mobile stations. Information about the locations and allocation of the downlink data bursts is included in the DL-MAP of the MAP region 104.

In the data burst allocation region 106, the abscissa axis is a time axis divided according to symbols, and the ordinate axis is a frequency axis divided according to frequencies. The data burst allocation region 106 divided according to the symbols and frequencies as described above includes sub-data burst allocation regions 108 to 112 to which the power boosting or de-boosting is applied. In FIG. 1, for example, the data burst allocation region 106 includes three sub-data burst regions, which include region #1 108, region #2 110, and region #3 112. The data bursts allocated to region #1 108 perform 3 dB power boosting, the data bursts allocated to region #2 110 perform 0 dB power boosting, and the data bursts allocated to region #3 112 perform −3 dB power boosting. Of course, the data burst region may be divided into one or more sub-data burst regions. Although the power boosting or de-boosting is performed for each data burst in the prior art, regions for the allocation of the data bursts are arranged in advance and the power boosting or de-boosting is then separately performed for each of the arranged regions.

In the following description, the data burst region is divided into two sub-data burst regions (which include a 3 dB power boosting region and a −3 dB power boosting region) or three sub-data burst regions (which include a 3 dB power boosting region, a 0 dB power boosting region, and a −3 dB power boosting region), and the number of sub-channels which can achieve an optimum performance is estimated for the cases of Full Usage of SubChannel (FUSC) and Partial Usage of SubChannel (PUSC) in the divided regions.

(3 dB, −3 dB) Division Scheme

First, it is assumed that the number of sub-channels which perform the 3 dB power boosting is x and the number of sub-channels which perform the −3 dB power boosting is y.

In the case of FUSC, which includes total 16 sub-channels, Equation (1) below is established by the maximum transmission power condition for each symbol.

$$2 x + \frac{1}{2} y \leq 16 \qquad ( 1 )$$

Division schemes, which can use all sub-channels while satisfying Equation (1), can be expressed by a set of {(1, 15), (2, 14), (3, 13), (4, 12), (5, 11)}. That is, the entire data burst region can be divided into a 3 dB power boosting region, which includes one sub-channel or two, three, four, or five sub-channels, and a −3 dB power boosting region, which includes 15, 14, 13, 12, or 11 sub-channels. Among the above-mentioned sub-channel division schemes, the (5, 11) sub-channel division scheme can use the maximum power for each symbol and is thus the most preferred division scheme.

In the case of PUSC, which includes total 30 sub-channels, Equation (2) below is established by the maximum transmission power condition for each symbol.

$$2 x + \frac{1}{2} y \leq 30 \qquad ( 2 )$$

Division schemes, which can use all sub-channels while satisfying formula (2), can be expressed by a set of {(1, 29), (2, 28), (3, 27), (4, 26), (5, 25), (6, 24), (7, 23), (8, 22), (9, 21), (10, 20)}. Among the above-mentioned sub-channel division schemes, the (10, 20) sub-channel division scheme can use the maximum power for each symbol and is thus the most preferred division scheme.

(3 dB 0 dB, −3 dB) Division Scheme

In comparison with the (3 dB, −3 dB) division scheme, the (3 dB, 0 dB, −3 dB) division scheme can more actively respond to the distribution of Carrier to Interference and Noise Ratio (CINR) of the mobile stations.

It is assumed that the number of sub-channels which perform the 3 dB power boosting is x, the number of sub-channels which perform the 0 dB power boosting is y, and the number of sub-channels which perform the −3 dB power boosting is z.

In the case of FUSC, which includes total 16 sub-channels, Equation (3) below is established by the maximum transmission power condition for each symbol.

$$2 x + y + \frac{1}{2} z \leq 16 \qquad ( 3 )$$

Among the natural number solutions which satisfy Equation (3), a condition for a solution which can allocate a maximum power while using all sub-channels corresponds to the case in which the equality sign is true. Further, it is required to satisfy the condition of z=2x by the −3 dB power boosting with respect to the 3 dB power boosting. Therefore, Equation (3) can be replaced by Equation (4) below.
3x+y=16 (4)

Therefore, a set of (x, y, z) which satisfies Equation (4) and the condition of z=2x includes {(1, 13, 2), (2, 10, 4), (3, 7, 6), (4, 4, 8), (5, 1, 10)}. Among these, the (3, 7, 6) or (4, 4, 8) sub-channel division schemes are the most preferred division schemes, in view of the CINR distribution of the mobile stations.

In the case of PUSC, which includes total 30 sub-channels, Equation (5) below is established by the maximum transmission power condition for each symbol.

$$2 x + y + \frac{1}{2} z \leq 30 \qquad ( 5 )$$

Among the natural number solutions which satisfy Equation (5), a condition for a solution which can allocate a maximum power while using all sub-channels corresponds to the case in which the equality sign is true. Further, it is required to satisfy the condition of z=2x by the −3 dB power boosting with respect to the 3 dB power boosting. Therefore, Equation (5) can be replaced by Equation (6) below.
3x+y=30 (6)

Therefore, a set of (x, y, z) which satisfies Equation (6) and the condition of z=2x includes {(1, 27, 2), (2, 24, 4), (3, 21, 6), (4, 18, 8), (5, 15, 10), (6, 12, 12), (7, 9, 14), (8, 6, 16), (9, 3, 8)}. Among these, (6, 12, 12) or (7, 9, 14) are the most preferred combinations, in view of the CINR distribution of the mobile stations.

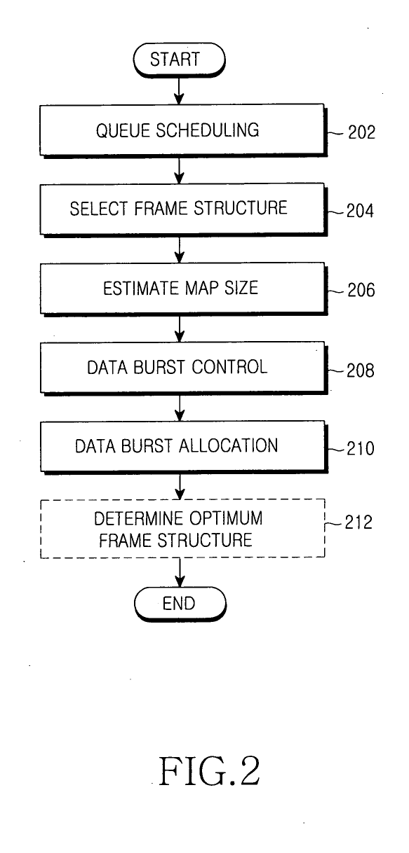

FIG. 2 is a flowchart of a process for resource allocation in a communication system according to the present invention.

As a premise prior to description with reference to FIG. 2, it is noted that data bursts can be allocated to an integer number of slots, and it is required to prevent occurrence of wasteful slots in the downlink frame during the two dimensional allocation of the data bursts according to the frequency and time. The downlink frame is divided by the frequency axis and the symbol axis (time axis) and includes a plurality of slots in which both the frequency and the time are reflected.

Referring to FIG. 2, in step 202, the base station performs a queue scheduling which determines the priority of each connection for the data bursts to be transmitted according to each service class. Then, in step 204, the base station determines how the base station will divide the data burst allocation region 106 of the downlink frame, and then selects a corresponding frame structure. The selected frame structure may be either a fixed structure determined in advance or a variable structure according to the characteristics of the data bursts to be transmitted. Further, the selected frame structure may be a frame structure as shown in FIG. 1, in which the data burst region includes a plurality of divided sub-data burst regions.

Then, in step 206, the base station estimates a MAP overhead necessary for the to-be-transmitted data bursts and determines the MAP size. The greater the number of data bursts to be transmitted, the greater the MAP size must be. However, when the setup MAP size is too large, the data burst region must be reduced. Therefore, the MAP size and the size of the data burst region must be properly determined through a trade-off process.

Then, in step 208, the base station performs data burst control which unites data bursts transmitted to the same mobile station or data bursts having the same Modulation and Coding Scheme (MCS) level into one data burst group in order to minimize the MAP overhead. The MCS includes combinations of modulation schemes and coding schemes, and it is possible to define a plurality of MCS levels from level 1 to level N.

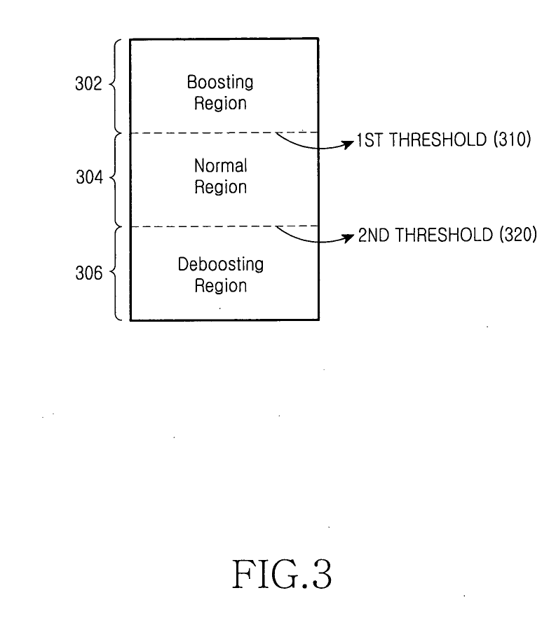

Then, in step 210, the base station allocates the data bursts, which are input according to the transmission priorities, to specific sub-data burst regions of the downlink frame according to a predetermined rule, which will be described later in more detail with reference to FIGS. 3 to 5.

Then, in step 212, the base station repeatedly performs steps 206 to 210, thereby determining an optimum frame structure which can best make use of resources from among the frame structures according to allocated data bursts. During this process, in order to reduce the complexity in implementing the process, it is possible to determine one frame structure in step 204 and is then possible to omit step 212.

FIG. 3 is a diagram illustrating the allocation of data bursts to a plurality of regions divided from a data burst region in a wireless access communication system according to an embodiment of the present invention.

Referring to FIG. 3, the data burst region is divided into three sub-data burst regions including a boosting region 302, a normal region 304, and a de-boosting region 306.

When the data burst to be allocated has a CINR value less than a first threshold 310, the data burst is allocated to the boosting region 302. When the data burst to be allocated has a CINR value greater than a second threshold 320, the data burst is allocated to the de-boosting region 306. Further, when the data burst to be allocated has a CINR value greater than the first threshold 310 and less than the second threshold 320, the data burst is allocated to the normal region 304. The CINR value of the data burst is a value, which is obtained by measuring the channel state between a mobile station and a base station, is fedback by the mobile station, and is used to determine the MCS level. In the case of initial data burst transmission which has no CINR value fedback from the mobile station, the base station can transmit the data burst by using the most robust modulation and coding scheme. From among the data bursts allocated to the normal region 304, any data burst showing no change in its MCS level after −3 dB power boosting is re-allocated to the de-boosting region 306. That is, the data burst re-allocated to the de-boosting region 306 shows no change in its MCS level even after −3 dB power boosting and has the same frequency efficiency as that before the −3 dB power boosting, so it can minimize extra power and enhance the entire power efficiency.

In the same manner, from among the data bursts allocated to the boosting region 302, any data burst showing no change in their MCS level after 3 dB power boosting is re-allocated to the normal region 304. That is, the data burst re-allocated to the normal region 304 shows no change in its MCS level even after 3 dB power boosting and has the same frequency efficiency as that before the 3 dB power boosting, so it also can minimize extra power and enhance the entire power efficiency.

Data Burst Allocation By Using Normal MAP

According to the present invention, in the case of using the normal MAP, it is possible to re-divide the sub-data burst region into a plurality of sub-data burst regions or groups. The groups have one or more sub-channels within each region. The sub-channels include one or more slots divided according to time. Further, the groups include single groups, each of which includes at least one sub-channel, and complex groups, each of which includes at least two combined single groups. Each of the sub-data burst regions may include either only one or both of the single group and the complex group.

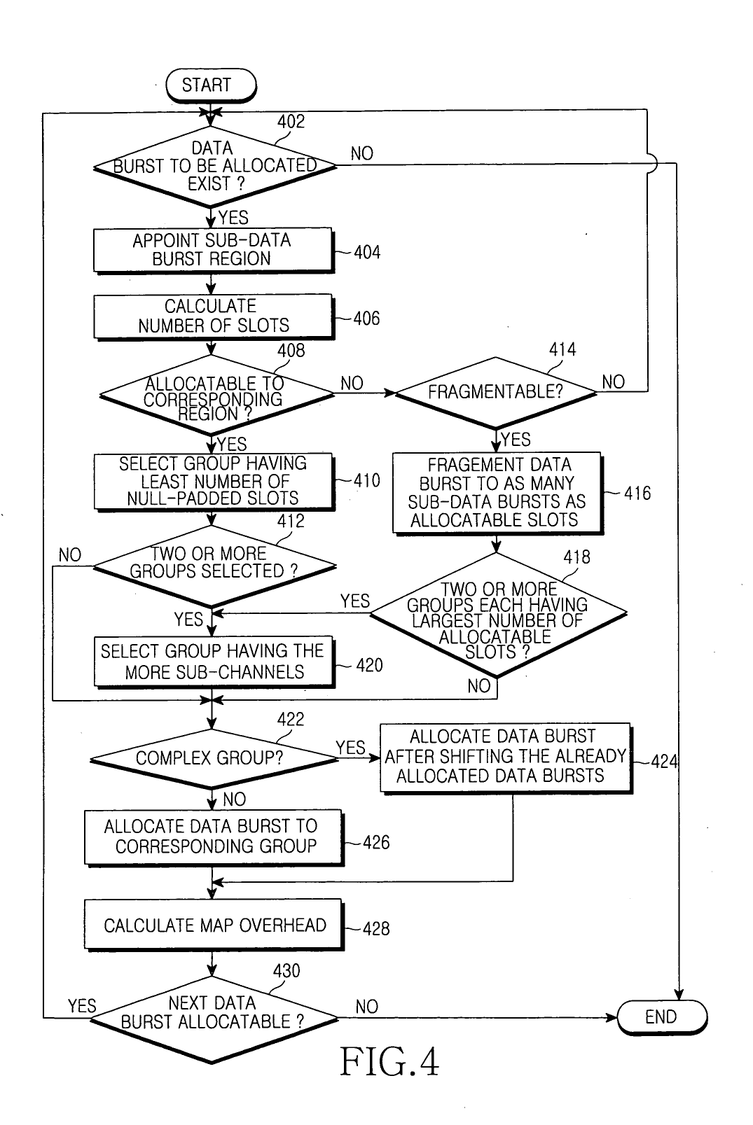

FIG. 4 is a flowchart of a process for data burst allocation in the case of using the normal MAP in a broadband wireless access communication system according to the present invention.

Referring to FIG. 4, in step 402, the base station determines if there is a data burst to be allocated to a data burst region. When there is a data burst to be allocated to a data burst region, the base station proceeds to step 404, in which the base station appoints a sub-data burst region, to which the data burst is to be allocated, in a predetermined frame structure. The frame structure is assumed to have the configuration as shown in FIG. 1. Therefore, the base station determines one of the sub-data burst regions, to which the data burst will be allocated, according to the process as described above with reference to FIG. 3.

Then, in step 406, the base station calculates the number of slots of the data burst. Then, in step 408, based on the calculated number of slots, the base station determines if it is possible to allocate all of the to-be-allocated data bursts to the determined sub-data burst region. As a result of the determination, the base station proceeds to step 410 when the calculated number of data burst slots are allocatable to the corresponding sub-data burst region, or otherwise proceeds to step 414. When the number of the sub-channels of the sub-data burst region is 10, the sub-data burst region may be divided into three single groups and two complex groups. That is, the sub-data burst region may include a single group #1 including three sub-channels, a single group #2 including three sub-channels, a single group #3 including four sub-channels, a complex group #1 including seven sub-channels of the single groups #2 and #3, and a complex group #2 including ten sub-channels of the single groups #1, #2 and #3. Table I as shown below illustrates a method for constructing the single groups and complex groups according to the number of sub-channels in each sub-data burst region.

For example, when the data burst has 14 slots and all of the 14 slots are allocated only to single groups, it is possible to allocate total 15 slots including 5 slots for each sub-channel to the single group #1 or #2, so that the single group may have one null-padded slot. However, it is possible to allocate total 14 slots including two slots for each sub-channel to the complex group #1, and it is thus possible to exactly allocate the 14 slots to the corresponding data burst with 0 null-padded slot, thereby minimizing the waste of resources. Therefore, by dividing the sub-data burst region into a plurality of single groups and complex groups, it is possible to minimize the waste of resources by maintaining the number of null-padded slots to be 0 as long as possible in allocating all possible data burst slots to each group. However, too many combinations of the single or complex groups may cause complexity in its implementation, and it is thus select a proper number of combinations of the groups for their implementation.

TABLE 1

| Number of | Number of | Number of |
|---|---|---|
| sub-channels | sub-channels | sub-channels |
| in each sub-data | in the case of single | in the case of complex |
| burst region | group construction | group construction |
| 1 | 1 | — |
| 2 | 2 | — |
| 3 | 3 | — |
| 4 | 4 | — |
| 5 | 2, 3 | 5 |
| 6 | 2, 4 | 6 |
| 7 | 3, 4 | 7 |
| 8 | 1, 3, 4 | 7, 8 |
| 9 | 2, 3, 4 | 5, 9 |
| 10 | 3, 3, 4 | 7, 10 |
| 11 | 3, 4, 4 | 7, 11 |
| 12 | 2, 3, 3, 4 | 5, 7, 12 |
| 13 | 2, 3, 4, 4 | 5, 8, 13 |
| 14 | 3, 3, 4, 4 | 6, 8, 14 |
| 15 | 3, 4, 4, 4 | 7, 8, 15 |
| 16 | 2, 3, 3, 4, 4 | 5, 7, 16 |
| 17 | 3, 3, 3, 4, 4 | 6, 7, 17 |
| 18 | 3, 3, 4, 4, 4 | 7, 8, 18 |
| 19 | 2, 3, 3, 3, 4, 4 | 5, 7, 19 |
| 20 | 2, 3, 3, 4, 4, 4 | 5, 7, 8, 20 |

In step 410, the base station selects a group having a least number of null-padded slots from among the single groups or complex groups. The null-padded slot refers to a slot remaining after allocation of the data bursts. Therefore, when there remain many null-padded slots, a lot of meaningless information is being transmitted.

Then, in step 412, the base station determines if there exist two or more groups having the same number of null-padded slots. According to the result of the determination, the base station performs step 420 when there exist two or more groups having the least number of null-padded slots and performs step 422 when there is only one group having the least number of null-padded slots.

Meanwhile, in step 414, the base station determines if it is possible to fragment the data burst. The base station proceeds to step 416 when it is possible to fragment the data burst. In contrast, when it is impossible to fragment the data burst, the base station concludes this as a failure in the data burst allocation and proceeds to step 402. In step 416, the base station fragments the data burst into as many sub-data bursts as the allocatable slots. Then, in step 418, the base station determines if there exist two or more groups each having the greatest number of allocatable slots. The base station proceeds to step 420 when there exist two or more groups each having the greatest number of allocatable slots, or otherwise proceeds to step 422.

In step 420, the base station selects a group having the more sub-channels as a data burst allocation group from the two or more groups. Then, in step 422, the base station determines if the selected group is a complex group. After the determination, the base station proceeds to step 424 when the selected group is a complex group or steps 426 when the selected group is a single group.

In step 424, the base station shifts data bursts having been allocated to a corresponding complex group, allocates the to-be-allocated data burst to the corresponding group, and then proceeds to step 428. If a new data burst is allocated to an allocatable complex group region without a shift of the data bursts having been allocated to the existing complex groups, an empty slot may occur between the existing data bursts and the newly allocated data burst, so that it is difficult to achieve efficient resource use and data burst allocation scheduling. In step 426, the base station allocates the data burst to slots of the corresponding group, i.e. the selected single group. Then, in step 428, the base station calculates the MAP overhead, according to the completion of the data burst allocation. The calculation of the MAP overhead is necessary in order to determine if the size of the MAP region allows allocation of a next data burst to the data burst region. Then, in step 430, the base station determines if any allocatable slot remains in the data burst region. The base station performs the process again from step 402 when any allocatable slot remains in the data burst region, or otherwise terminates the data burst allocation.

Data Burst Allocation By Using New DL (Normal) MAP or H-ARQ MAP

In the case of data burst allocation by using the new DL MAP or H-ARQ MAP, one-dimensional slot allocation to the frequency axis is performed after the sub-data burst region to which the data burst is allocated is determined. When the to-be-allocated data burst is left after the slot allocation is completed, slot allocation to the frequency axis of the next symbol is performed. The new DL MAP is a MAP which is available regardless of whether a mobile station supports the H-ARQ scheme or not. Therefore, the data burst allocation by using the new DL MAP or H-ARQ MAP does not require the single group or complex group, differently from the data burst allocation by using the normal MAP.

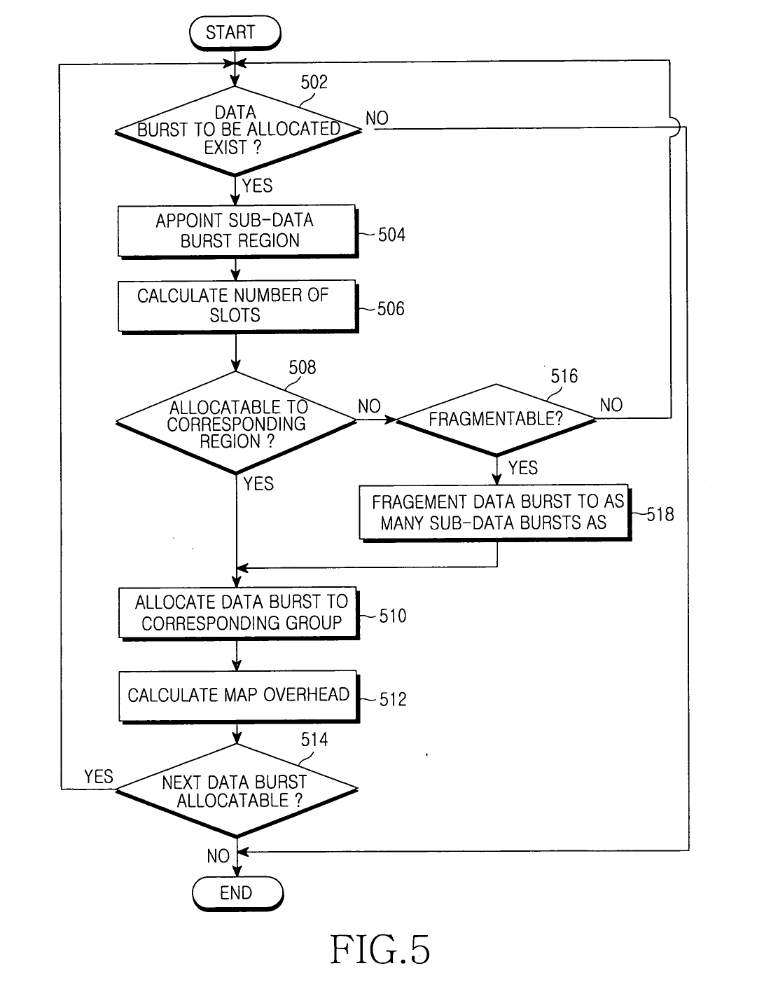

FIG. 5 is a flowchart of a process for data burst allocation in the case of using the new DL MAP or H-ARQ MAP in a broadband wireless access communication system according to the present invention.

Referring to FIG. 5, in step 502, the base station determines if there is a data burst to be allocated to an H-ARQ MAP received from an upper layer. When there is a data burst to be allocated to the H-ARQ MAP, the base station proceeds to step 504, in which the base station appoints a sub-data burst region, to which the data burst is to be allocated. The process in which the base station appoints the sub-data burst region is the same as the process as described above with reference to FIG. 3.

Then, in step 506, the base station calculates the number of slots of the data burst. Then, in step 508, based on the calculated number of slots, the base station determines if it is possible to allocate all of the to-be-allocated data burst to the determined sub-data burst region. Based on the result of the determination, the base station proceeds to step 510 when the calculated number of data burst slots are allocatable to the corresponding sub-data burst region, or otherwise proceeds to step 516.

In step 510, the base station allocates the data burst to the corresponding sub-data burst region. Then, in step 512, the base station calculates the MAP overhead, in order to determine if the size of the MAP region allows allocation of a next data burst to the data burst region. Then, in step 514, the base station determines if any slot to which a next data burst can be allocated is left in the corresponding sub-data burst region. The base station performs the process again from step 502 when any slot to which a next data burst can be allocated is left in the data burst region.

Meanwhile, in step 516, the base station determines if it is possible to fragment the data burst. The base station proceeds to step 518 when it is possible to fragment the data burst. In contrast, when it is impossible to fragment the data burst, the base station concludes this as a failure in the data burst allocation and proceeds to step 502. In step 518, the base station fragments the data burst into as many sub-data bursts as the allocatable slots. For example, when the sub-data burst region includes eight allocatable slots and the fragmentable data burst requires ten slots to occupy, eight sub-data bursts of the ten divided sub-data bursts are first allocated to the eight slots of the sub-data burst region and the two remaining sub-data bursts are then allocated to two slots of the next sub-data burst region at the time of next downlink frame transmission.

In a communication system according to the present invention as described above, it is possible to efficiently allocate data bursts to a data burst allocation region of a downlink frame including sub-data burst regions which perform predetermined power posting. Therefore, the present invention can maximize the efficiency in use of resources of the entire system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for resource allocation for a data burst in a communication system having a frame which is divided according time and frequency and includes a data burst allocation region, the method comprising the steps of:
(a) constructing the frame to have a structure in which the data burst allocation region is divided into at least one sub-data burst region for power amplification at a preset power level; and
(b) allocating the data burst to the sub-data burst region according to a standard.

2. The method as claimed in claim 1, wherein the preset power level is one of power levels including 0 dB, ±3 dB, ±6 dB, ±9 dB, and ±12 dB.

3. The method as claimed in claim 1, wherein, when the data burst allocation region is divided into two sub-data burst regions, step (b) comprises comparing a Carrier to Interference Noise Ratio (CINR) of data to be transmitted with a predetermined threshold; and
allocating a data burst having a CINR greater than the threshold to a sub-data burst region for power amplification at a first power level and a data burst having a CINR less than the threshold to a sub-data burst region for power amplification at a second power level.

4. The method as claimed in claim 3, wherein the first power level is one of power levels including 0 dB, ±3 dB, ±6 dB, ±9 dB, and ±12 dB, and the second power level has a decibel greater than that of the first power level.

5. The method as claimed in claim 1, wherein, when the data burst allocation region is divided into three sub-data burst regions, step (b) comprises:
comparing a CINR of data to be transmitted with a first threshold and a second threshold; and
allocating a data burst having a CINR less than the first threshold to a sub-data burst region for power amplification at a first power level, a data burst having a CINR greater than the first threshold and less than the second threshold to a sub-data burst region for power amplification at a second power level, and a data burst having a CINR greater than the second threshold to a sub-data burst region for power amplification at a third power level.

6. The method as claimed in claim 5, wherein the first power level is one of power levels including 0 dB, ±3 dB, ±6 dB, ±9 dB, and ±12 dB, the second power level has a decibel level less than that of the first power level, and the third power level has a decibel level less than that of the second power level.

7. The method as claimed in claim 5, wherein, from among data bursts allocated to the sub-data burst region for power amplification at the second power level, a data burst showing no change in its Modulation and Coding Scheme (MCS) level after −3 dB power boosting is re-allocated to the sub-data burst region for power amplification at the third power level.

8. The method as claimed in claim 5, wherein, from among data bursts allocated to the sub-data burst region for power amplification at the first power level, a data burst showing no change in its MCS level after 3 dB power boosting is re-allocated to the sub-data burst region for power amplification at the second power level.

9. The method as claimed in claim 5, wherein the second threshold is greater than the first threshold.

10. A method for resource allocation for a data burst in a communication system having a frame divided according time and frequency and data bursts to be transmitted to a mobile station, the frame including a MAP region and a data burst allocation region, the MAP region carrying broadcast information, the method comprising the steps of:
(a) constructing the frame to have a structure in which the data burst allocation region is divided into at least one sub-data burst region for power amplification at a preset power level, the sub-data burst region including at least one group divided according to a sub-channel;
(b) allocating the data burst to the sub-data burst region according to a standard;
(c) when the sub-data burst region includes enough slots to be occupied by all of the data burst, selecting a group having a lowest number of remaining slots after occupancy of the data burst; and
(d) allocating the data burst to the selected group.

11. The method as claimed in claim 10, further comprising, when the sub-data burst region has at least two groups each having the lowest number of remaining slots after occupancy of the data burst, selecting a group having more sub-channels from among said at least two groups.

12. The method as claimed in claim 10, further comprising:
when the sub-data burst region includes slots which only a part of the data burst can occupy, determining if it is possible to fragment the data burst;
when it is possible to fragment the data burst, selecting a group having a greatest number of occupiable slots which the data burst can occupy;
fragmenting the data burst into as many sub-data bursts as the occupiable slots; and
allocating the sub-data bursts to the occupiable slots.

13. The method as claimed in claim 12, wherein sub-data bursts remaining after allocation of the sub-data bursts to the corresponding group are transmitted at a next downlink frame.

14. The method as claimed in claim 10, wherein the preset power level is one of power levels including 0 dB, ±3 dB, ±6 dB, ±9 dB, and ±12 dB.

15. The method as claimed in claim 10, wherein, when the data burst allocation region is divided into two sub-data burst regions, step (b) comprises:
comparing a Carrier to Interference Noise Ratio (CINR) of data to be transmitted with a threshold; and
allocating a data burst having a CINR greater than the threshold to a sub-data burst region for power amplification at a first power level and a data burst having a CINR less than the threshold to a sub-data burst region for power amplification at a second power level.

16. The method as claimed in claim 15, wherein the first power level is one of power levels including b 0 dB, ±3 dB, ±6 dB, ±9 dB, and ±12 dB, and the second power level has a decibel greater than that of the first power level.

17. The method as claimed in claim 10, wherein, when the data burst allocation region is divided into three sub-data burst regions, step (b) comprises:
comparing a CINR of data to be transmitted with a first threshold and a second threshold; and
allocating a data burst having a CINR less than the first threshold to a sub-data burst region for power amplification at a first power level, a data burst having a CINR greater than the first threshold and less than the second threshold to a sub-data burst region for power amplification at a second power level, and a data burst having a CINR greater than the second threshold to a sub-data burst region for power amplification at a third power level.

18. The method as claimed in claim 17, wherein the first power level is one of power levels including 0 dB, ±3 dB, ±6 dB, ±9 dB, and ±12 dB, the second power level has a decibel level less than that of the first power level, and the third power level has a decibel level less than that of the second power level.

19. The method as claimed in claim 17, wherein, from among data bursts allocated to the sub-data burst region for power amplification of the second power level, a data burst showing no change in its Modulation and Coding Scheme (MCS) level after −3 dB power boosting is re-allocated to the sub-data burst region for power amplification at the third power level.

20. The method as claimed in claim 17, wherein, from among data bursts allocated to the sub-data burst region for power amplification of the first power level, a data burst showing no change in its MCS level after 3 dB power boosting is re-allocated to the sub-data burst region for power amplification at the second power level.

21. The method as claimed in claim 17, wherein the second threshold is greater than the first threshold.

22. The method as claimed in claim 17, further comprising terminating allocation of the data burst when the MAP region cannot record allocation information according to the allocation of the data burst.

23. A method for resource allocation for a data burst in a communication system having a frame divided according time and frequency and data bursts to be transmitted to a mobile station, the frame including a MAP region and a data burst allocation region, the MAP region carrying Hybrid-ARQ broadcast information, the method comprising the steps of:
(a) constructing the frame to have a structure in which the data burst allocation region is divided into at least one sub-data burst region for power amplification at a preset power level;
(b) allocating the data burst to the sub-data burst region according to a standard; and
(c) when the sub-data burst region includes enough slots to be occupied by all of the data burst, sequentially allocating the data burst to the slots along a frequency axis.

24. The method as claimed in claim 23, wherein the preset power level is one of power levels including 0 dB, ±3 dB, ±6 dB, ±9 dB, and ±12 dB.

25. The method as claimed in claim 23, wherein, when the data burst allocation region is divided into two sub-data burst regions, step (b) comprises:
comparing a Carrier to Interference Noise Ratio (CINR) of data to be transmitted with a threshold; and
allocating a data burst having a CINR higher than the threshold to a sub-data burst region for power amplification at a first power level and a data burst having a CINR less than the threshold to a sub-data burst region for power amplification at a second power level.

26. The method as claimed in claim 25, wherein the first power level is one of power levels including 0 dB, ±3 dB, ±6 dB, ±9 dB, and ±12 dB, and the second power level has a decibel greater than that of the first power level.

27. The method as claimed in claim 23, wherein, when the data burst allocation region is divided into three sub-data burst regions, step (b) comprises:
comparing a CINR of data to be transmitted with a first threshold and a second threshold; and
allocating a data burst having a CINR less than the first threshold to a sub-data burst region for power amplification at a first power level, a data burst having a CINR greater than the first threshold and less than the second threshold to a sub-data burst region for power amplification at a second power level, and a data burst having a CINR greater than the second threshold to a sub-data burst region for power amplification at a third power level.

28. The method as claimed in claim 27, wherein the first power level is one of power levels including 0 dB, ±3 dB, ±6 dB, ±9 dB, and ±12 dB, the second power level has a decibel level less than that of the first power level, and the third power level has a decibel level less than that of the second power level.

29. The method as claimed in claim 27, wherein, from among data bursts allocated to the sub-data burst region for power amplification of the second power level, a data burst showing no change in its Modulation and Coding Scheme (MCS) level after −3 dB power boosting is re-allocated to the sub-data burst region for power amplification at the third power level.

30. The method as claimed in claim 27, wherein, from among data bursts allocated to the sub-data burst region for power amplification at the first power level, a data burst showing no change in its MCS level after 3 dB power boosting is re-allocated to the sub-data burst region for power amplification at the second power level.

31. The method as claimed in claim 23, wherein the second threshold is greater than the first threshold.

32. The method as claimed in claim 23, further comprising terminating allocation of the data burst when the MAP region cannot record allocation information according to the allocation of the data burst.
